(19) United States
(12) Patent Application Publication
(10) Pub. No.: US 2014/0293598 A1
(43) Pub. Date: Oct. 2, 2014

(54) Illuminated wall-mounted apparatus, counter-top apparatus, enclosures, cabinets and tables

(71) Applicants: Steven Bruck, Manhasset, NY (US); Robert Bruck, Roslyn, NY (US)

(72) Inventors: Steven Bruck, Manhasset, NY (US); Robert Bruck, Roslyn, NY (US)

(21) Appl. No.: 13/986,128

(22) Filed: Apr. 2, 2013

(51) Int. Cl. F21V 33/00

(52) U.S. Cl. CPC F21V 33/00
USPC 362/234

(57) ABSTRACT

An illuminating apparatus is provided. The illuminating apparatus can be mounted to tables, cabinets, counter-top enclosures, wall-mounted enclosures and other types of enclosures. The illuminating apparatus includes a light assembly mounted to a bottom, or side surface of the enclosure. The light assembly includes many visible-light emitting elements, and is arranged to illuminate an area directly adjacent to the bottom surface of the enclosure, as well as an area directly beneath the enclosure.

### FIELD OF THE INVENTION

The present invention generally relates to illumination methods. More particularly, the invention concerns a methods and apparatus to illuminate a variety of different enclosures, tables, cabinets and other apparatus.

### BRIEF DESCRIPTION OF THE DRAWINGS

FIG. 1 is a perspective view of a vending machine embodying the principals of the invention;

FIG. 2 is a perspective view of a floor mounted automated teller machine embodying the principals of the invention;

FIG. 3 is a perspective view of an arcade game embodying the principals of the invention;

FIG. 4 is a perspective view of a table embodying the principals of the invention;

FIG. 5 is a perspective view of a pinball machine embodying the principals of the invention;

FIGS. 6A-B are perspective views of counter-top machines embodying the principals of the invention;

FIG. 7 is a perspective view of a slot machine embodying the principals of the invention; and

FIG. 8 is a perspective view of a wall-mounted automated teller machine embodying the principals of the invention.

It will be recognized that some or all of the Figures are schematic representations for purposes of illustration and do not necessarily depict the actual relative sizes or locations of the elements shown. The Figures are provided for the purpose of illustrating one or more embodiments of the invention.

### DETAILED DESCRIPTION OF THE PREFERRED EMBODIMENTS

In the following description, for the purposes of explanation, numerous specific details are set forth in order to provide a thorough understanding of the Illumination Apparatus (hereinafter “IA”). It will be apparent, however, to one skilled in the art that the IA may be practiced without some of these specific details. Throughout this description, the embodiments and examples shown should be considered as exemplars, rather than as limitations on the IA. That is, the following description provides examples, and the accompanying drawings show various examples for the purposes of illustration. However, these examples should not be construed in a limiting sense as they are merely intended to provide examples of the IA rather than to provide an exhaustive list of all possible implementations of the IA.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention.

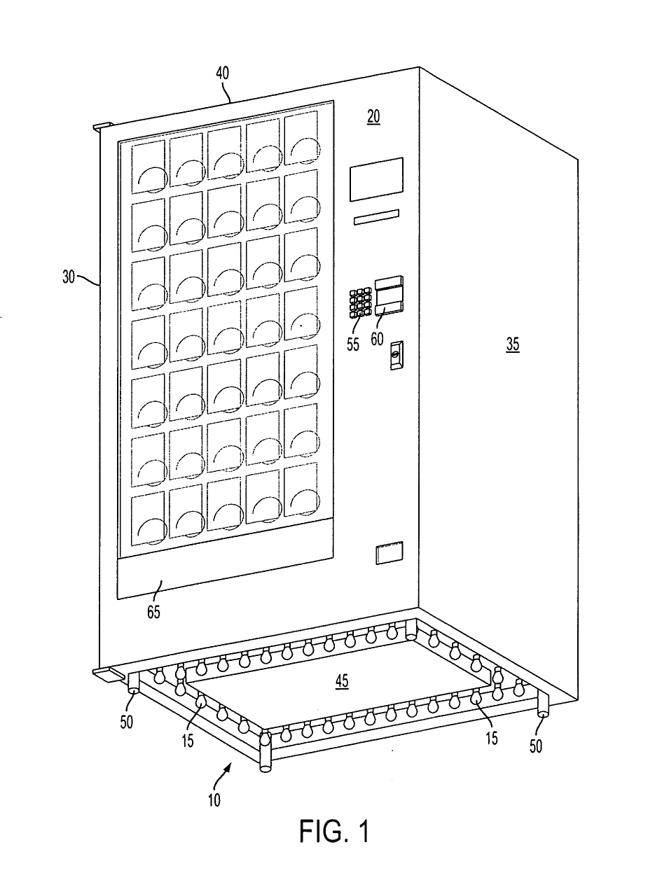

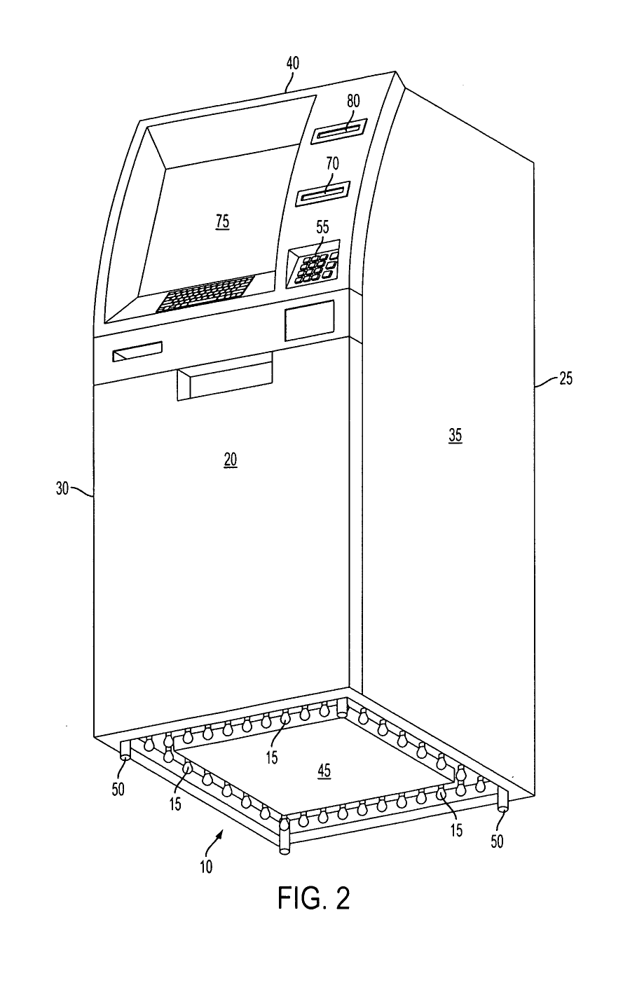

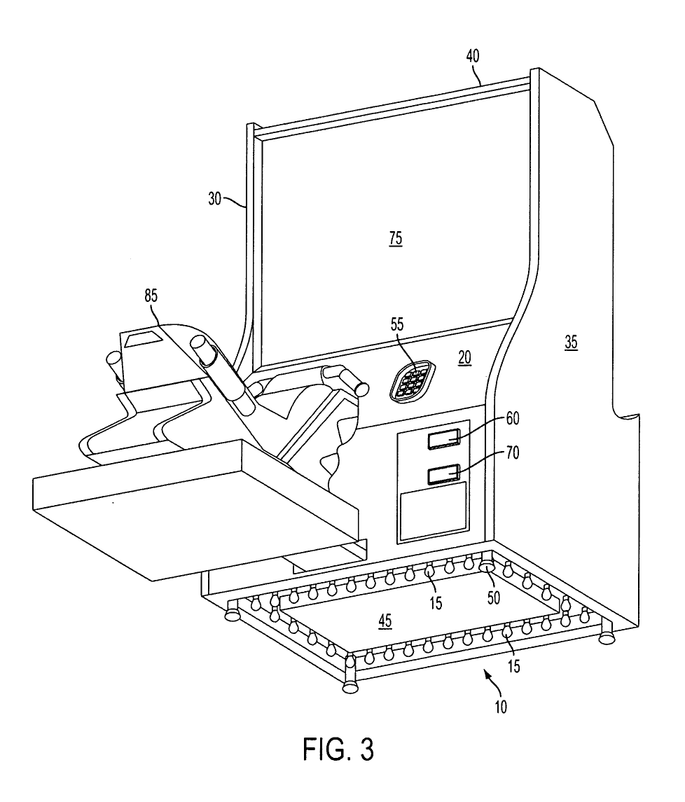

Referring now to FIGS. 1-2, one embodiment of the illumination apparatus (“IA”) 10 comprises an apparatus and system that illuminates the bottom, or lower surface of a table, or apparatus housed in a cabinet, enclosure or housing. The IA 10 may also be employed in wall-mounted apparatus. For example, in the illustrated embodiment shown in FIG. 1, the IA 10 comprises a plurality of lights 15 mounted on a bottom surface of a vending machine. This embodiment of the IA 10 may be installed on any type of apparatus that includes a cabinet or enclosure, such as a vending machine, or an automated teller machine (shown in FIG. 2), a token dispenser, a water dispenser, an entertainment machine (i.e., a photo booth, or an arcade game, shown in FIG. 3) or any apparatus that dispenses a product or provides a service or provides entertainment.

For example, as shown in FIGS. 1-2, the IA 10 may be installed on a cabinet or enclosure that may include a front surface 20, a rear surface 25, a left surface 30, a right surface 35, a top surface 40 and a bottom surface 45. An understanding of the orientation of the different surfaces can be achieved by visualizing the perspective of an individual standing in front of, and facing the enclosure. The left surface 30 is the left side of the enclosure, which is closest to the left hand of the individual. The front surface 20 is the surface of the enclosure facing the individual, and the bottom surface 45 is the surface of the enclosure that faces the ground or floor that the individual is standing on. It will be appreciated that the shape of the cabinet or enclosure may vary, for example, the enclosure may be round, oval, pyramidal, or take other forms, and therefore not include all of the above-described surfaces.

In the embodiment illustrated in FIGS. 1-2, the IA 10 comprises a plurality of light-emitting elements 15 located along the bottom edge of the enclosure. The lights 15 comprise a plurality of light emitting diodes (LEDs). For example, in one embodiment, the LEDs may emit a blue light. In other embodiments, the LEDs may emit red, amber, purple, or green light. In addition, the lights 15 may be programmed to change colors. Other embodiments of the lights 15 may comprise one or more incandescent lights, halogen lights, fluorescent lights, or any other type of device that emits electromagnetic radiation that is perceived by the human eye. For example, a light constructed using field-induced polymer electroluminescent (FIPEL) technology may be employed. FIPEL is a low power electroluminescent light source. Three layers of moldable light-emitting polymer blended with a small amount of carbon nanotubes glow when an alternating current is passed through them. FIPEL lights can produce white light similar to that of the Sun, or other tints if desired. It is also more efficient than compact fluorescent lamps in terms of the energy required to produce light. In addition, optical fibers may be employed as the light-emitting elements 15. Also, one or more mirrors may be employed to provide reflected light. It will also be appreciated that the lights 15 may emit other colors, as desired.

In one embodiment, the lights 15 comprise LEDs mounted in a flexible strip located within a silicone rubber tube. The lights 15 are connected to a wiring element (not shown), or a controller that may comprise another part of the IA 10. The wiring element, or controller is connected to a power source that may be located on the enclosure, or located adjacent to the enclosure. It will be appreciated that other constructions of lights 15, wiring and controllers may be employed.

The lights 15 are coupled adjacent to the edge of the bottom surface 45 where it meets the front surface 20, rear surface 25, and left 30 and right 35 surfaces, so that the emitted light illuminates a light impact zone located on the floor, or other surface that the enclosure rests upon. Different enclosures or housings may include different supports, such as legs 50, or wheels that contact the floor and position the enclosure above the floor. It will be appreciated that the lights 15 may be located anywhere on the bottom surface 45, and the enclosure may be supported by elements other than legs or wheels. In addition, the IA 10 may include a channel or other type of housing (not shown) located along one, or both sides of the lights 15. The channel may be mounted to the bottom surface 45, and provide protection for the lights 15 from impacts or contamination.

The light impact zone may extend from an area defined by the perimeter of the housing, or enclosure that comprises the front surface 20, the rear surface 25, the left surface 30, and the right surface 35, to a range of about a foot or two from the perimeter of the enclosure. The light impact zone would include the ground, floor, or other surface that the enclosure rests upon so that the bottom surface 45 is illuminated, as well as the ground, or floor that is directly under the bottom surface 45 of the enclosure. In addition, if the enclosure is located within a foot or so of a vertical surface, such as a wall, the area where the wall intersects with the floor may also be included within the light impact zone.

In another embodiment of the IA 10 (not shown), the lights 15 may be mounted within the housing, or enclosure adjacent to the bottom surface 45, which would have slots, holes or other apertures located therein, so that light emitted from the lights 15 would create a light impact zone.

Another feature of the IA 10 is operation of the lights 15. For example, in one embodiment, a customer may approach the enclosure, and the IA 10 detects the customer presence by an electrical eye, or other system, such as a proximity sensor. The lights 15 may increase their illumination, or the lights 15 may be illuminated in a flashing, strobe, consecutive, sequential, or other type of illumination pattern. Customer presence may also be detected in other ways, such as buttons are pressed, a bill is inserted, or the touch screen is touched. If a customer presence is detected, the lights 15 may increase their illumination, or the lights 15 may be illuminated in a flashing, strobe, consecutive, sequential, or other type of illumination pattern.

Also, in one embodiment, when there are no customers interacting with the enclosure, the IA 10 may change into an attract mode where the lights 15 may increase their illumination, or the lights 15 may be illuminated in a flashing, strobe, consecutive, sequential, or other type of illumination pattern.

The embodiments illustrated in FIGS. 1-2 show the IA 10 coupled to one type of cabinet or enclosure. For example, FIG. 1 illustrates a vending machine, and FIG. 2 illustrates an automated teller machine. The vending machine includes a dispensing element structured to dispense an article, such as a rotatable helical element. It will be appreciated that the IA 10 may be coupled to any type of vending machine that dispensed a variety of items, such as edible items, non-edible items, beverages like alcohol, soft drinks, soda, other liquid drinks, as well as ice cream, candy, video games, DVDs, snacks, cigarettes, lottery tickets, and cologne.

For example, as shown in FIG. 1, the vending machine includes a keypad, touch-screen, or other type customer selection element 55 accessible by a customer to select an article, with the customer selection element 55 located on the front surface 20 of the enclosure. A bill receiver, or other type of currency receiver element 60 structured to receive a currency for purchasing the article is located on the front surface 20 of the enclosure.

The currency receiver element 60 may comprise a credit card reader, a bill acceptor, a coin acceptor, a token acceptor, and a combination of two or more thereof. In addition, a digital payment system may be employed. Digital payment systems comprise payment mechanisms that use cell phones, thumb prints, code numbers and other means to effect payment. For example, a matrix bar code reader may be employed, such as a Quick Response Code (QR), which is a trademark for a type of matrix barcode (or two-dimensional bar code). The code consists of black modules (square dots) arranged in a square grid on a white background. The information encoded may be made up of four standardized types (“modes”) of data (numeric, alphanumeric, byte, or binary) or, through supported extensions, virtually any type of data. A QR code is read by an imaging device, such as a camera, and formatted algorithmically by underlying software using Reed-Solomon error correction until the image can be appropriately interpreted. Data is then extracted from patterns present in both horizontal and vertical components of the image.

Finally, a receiving area 65 is located on the front surface 20 of the enclosure that allows the customer to obtain the article after the article has been selected, purchased and dispensed.

The cabinet or enclosure illustrated in FIG. 2 also comprises a front surface 20, a rear surface 25, a left surface 30, a right surface 35, a top surface 40 and a bottom surface 45. FIG. 2 illustrates an automated teller machine that includes a keypad 55, a card reader 70 that receivers a customer's debit or credit card, a monitor or display 75 that displays information, and a dispenser 80 that dispenses currency. The IA 10 is coupled to the bottom surface 45 with lights 15 arranged near the bottom edge of the front surface 20, rear surface 25, left surface 30, and right surface 35. It will be appreciated that the lights 15 may not be mounted to the bottom edge of all the surfaces, depending on the location of the enclosure. For example, for an enclosure mounted against a wall, lights 15 may only be mounted near the bottom edge of the front surface 20, left surface 30, and right surface 35. The function of the IA 10 described above in connection with FIGS. 1-2 applies to the automated teller machine as well.

The description above with reference to FIGS. 1-2 relates to the application of the IA 10 to two apparatus housed in cabinets or enclosures. However, the IA 10 is not limited to vending machines and automated teller machines. The IA 10 may be installed on, or in other enclosures such as jukeboxes, photo booths, token dispensers, and arcade games (i.e., entertainment machines) such as boxing games, pachinko games, shoot arenas, coin-shooters, pushers, and ticket redemption games, among others.

FIG. 3 illustrates the IA 10 installed on an arcade game that includes a seat 85 for the operator, and curved surfaces. However, the arcade game includes a front surface 20, a rear surface 25, a left surface 30, a right surface 35, a top surface 40 and a bottom surface 45. This arcade game also includes a keypad 55, bill receiver 60, card reader 70, and a display 75. The IA 10 is coupled to the bottom surface 45 with lights 15 arranged near the bottom edge of the front surface 20, rear surface 25, left surface 30, and right surface 35. It will be appreciated that the lights 15 may not be mounted to the bottom edge of all the surfaces, depending on the location of the arcade game. For example, if the arcade game is mounted against a wall, lights 15 may only be mounted near the bottom edge of the front surface 20, left surface 30, and right surface 35.

The functions of the IA 10 described above in connection with FIGS. 1-2 apply to the arcade game illustrated in FIG. 3 as well. That is, the lights 15 of the IA 10 illuminate a surface located directly beneath the bottom surface of the arcade game illustrated in FIG. 3, as well as illuminating a light impact zone adjacent to the bottom surface of the arcade game. The lights 15 are also capable of the different illumination functions described above.

In addition, the IA 10 may be installed on other types of arcade games having seats or chairs, such as auto racing games, snow-cross games, and flying games that depict fighter planes, helicopters and other aircraft.

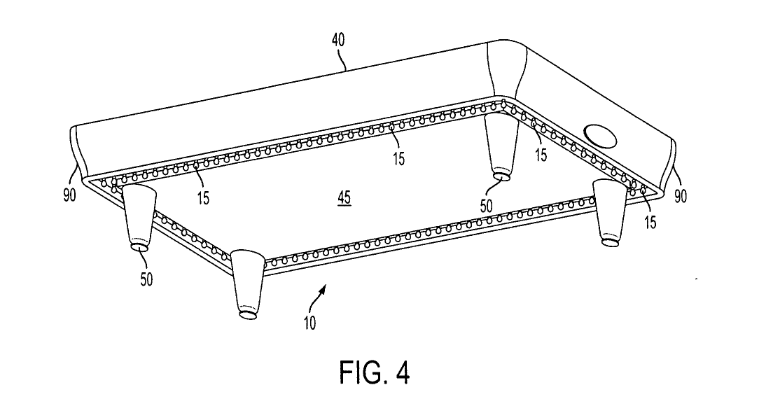

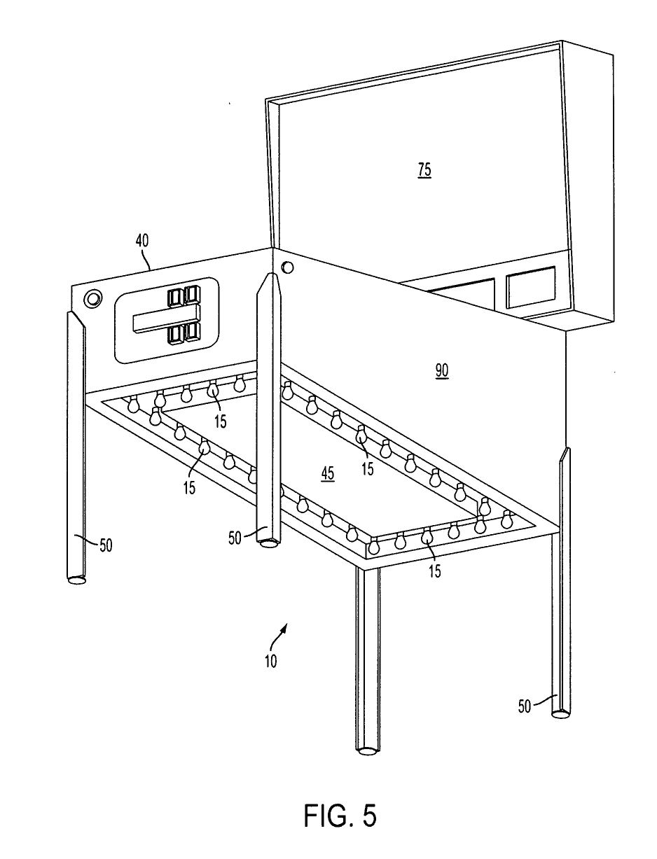

Referring now to FIGS. 4-5, another embodiment of the IA 10 is illustrated. This embodiment of the IA 10 is configured to couple to apparatus having a substantially rectangular enclosure comprising a top surface 40, a bottom surface 45, and four side surfaces 90. The substantially rectangular enclosure also includes four legs 50 extending from the substantially rectangular enclosure. Examples of this type of substantially rectangular enclosures are pool tables, a billiards tables, air hockey tables, pinball machines, and other types of games played on a substantially rectangular surface. However, the IA 10 may also be coupled to square, round and other shaped enclosures.

As shown in FIG. 4, the top surface 40 comprises a playing surface, such as an air hockey playing surface or a pool table playing surface. In FIG. 5, the top surface 40 may comprise a substantially transparent surface though which the operator can see, for example, in the case of a pinball machine, which also includes a display 75.

As shown in FIGS. 4-5, the IA 10 is coupled to the bottom surface 45 with lights 15 arranged near the bottom edge of the side surfaces 90. It will be appreciated that the lights 15 may not be mounted to the bottom edge of all the surfaces, depending on the location of the substantially rectangular enclosure. For example, if a pinball game is mounted against a wall, lights 15 may only be mounted near the bottom edge of the side surfaces 90 that face away from, or are substantially perpendicular to the wall.

The functions of the IA 10 described above in connection with FIGS. 1-2 apply to the substantially rectangular enclosures illustrated in FIGS. 4-5 as well. That is, the lights 15 of the IA 10 illuminate a surface located directly beneath the bottom surface of the substantially rectangular enclosure, as well as illuminating a light impact zone adjacent to the bottom surface of the substantially rectangular enclosure. The lights 15 are also capable of the different illumination functions described above.

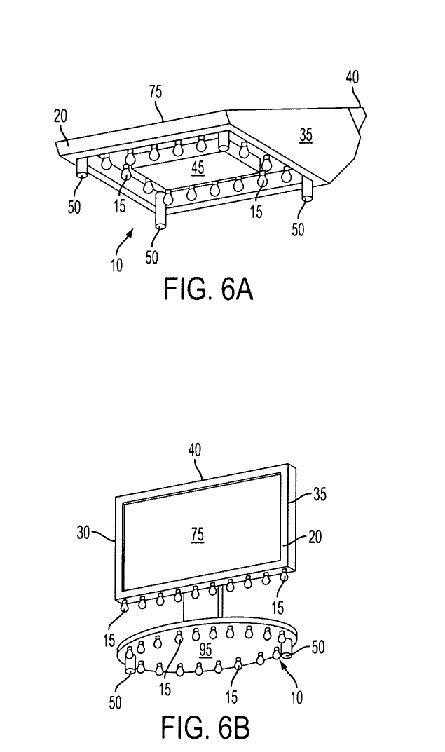

Referring now to FIGS. 6A-B, another embodiment of the IA 10 is illustrated. This embodiment of the IA 10 is configured to couple to an enclosure sized to be locatable upon a counter-top, which is a horizontal surface elevated above a support surface upon which an individual stands. Counter-tops are found in banks, bars and other types of businesses. The illustrated enclosure includes a front surface 20, a rear surface (not shown), a left surface 30, a right surface 35, a bottom surface 45, and legs 50. The enclosure sized to be locatable upon a counter-top so that a lower portion of each of the front, rear, left and right surfaces is adjacent to the counter-top. A display 75, or other type of customer interface is located on the front surface of the enclosure, the display 75 may be a touch-screen monitor that the customer employs to operate the apparatus, which may be a video poker game, a photo processor, an information kiosk, or any type of entertainment machine, or service machine.

The embodiment illustrated in FIG. 6B includes a rotatable and/or tiltable enclosure mounted on a pedestal 95. Similar to the embodiment illustrated in FIG. 6A, the enclosure comprises a front surface 20, a rear surface (not shown), a left surface 30, a right surface 35 and a bottom surface 45.

As shown in FIG. 6A, the IA 10 is coupled to the bottom surface 45 with lights 15 arranged near the edge of the bottom surface 45. In the embodiment illustrated in FIG. 6B, the IA 10 is coupled to the bottom surface 45 with lights 15 arranged near the edge of the bottom surface 45, thereby illuminating the pedestal 95.

The functions of the IA 10 described above in connection with FIGS. 1-2 apply to the enclosures illustrated in FIGS. 6A-B as well. That is, the lights 15 of the IA 10 illuminate a surface located directly beneath the bottom surface of the enclosure illustrated in FIGS. 6A-B, as well as illuminating a light impact zone adjacent to the bottom surface of the enclosure. The lights 15 are also capable of the different illumination functions described above.

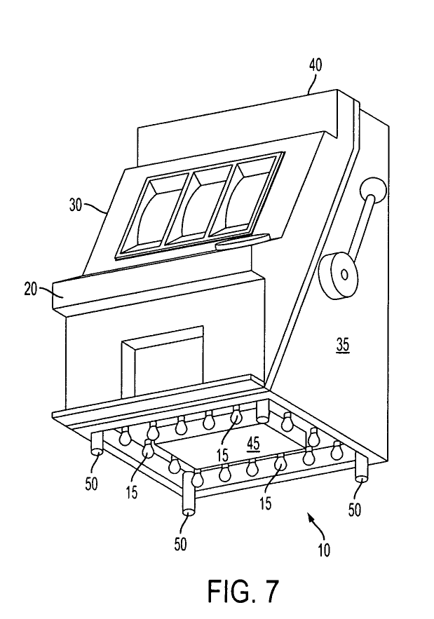

Referring now to FIG. 7, another embodiment of the IA 10 is illustrated. This embodiment of the IA 10 is configured to couple to a slot machine, which may be mounted on a counter-top or may be self-supporting. The slot-machine comprises an enclosure having a front surface 20, a rear surface (not shown), a left surface 30, a right surface 35, a top surface 40, a bottom surface 45, and legs 50. In one embodiment, the slot machine is sized to be locatable upon a counter-top so that a lower portion of each of the front, rear, left and right surfaces is adjacent to the counter-top. The IA 10 is coupled to the bottom surface 45 with lights 15 arranged near the edge of the bottom surface 45.

The functions of the IA 10 described above in connection with FIGS. 1-2 apply to the slot-machine illustrated in FIG. 7 as well. That is, the lights 15 of the IA 10 illuminate a surface located directly beneath the bottom surface of the slot-machine illustrated in FIG. 7, as well as illuminating a light impact zone adjacent to the bottom surface of the slot-machine. The lights 15 are also capable of the different illumination functions described above.

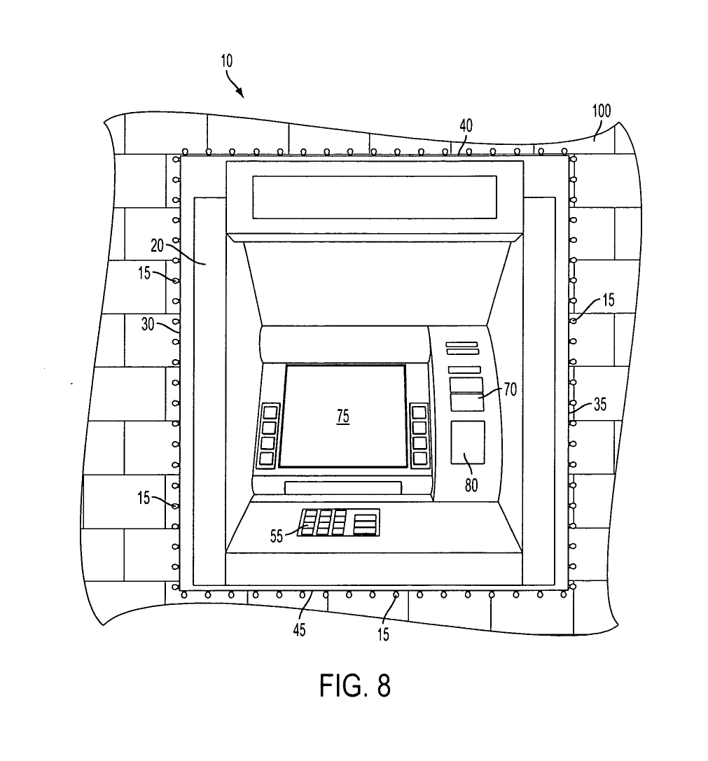

Finally, as shown in FIG. 8, a wall-mounted embodiment of the IA 10 is illustrated. This embodiment comprises an enclosure mounted to a wall, or other surface. The cabinet or enclosure illustrated in FIG. 8 comprises a front surface 20, a left surface 30, a right surface 35, a top surface 40 and a bottom surface 45. FIG. 8 illustrates an automated teller machine (ATM) that includes a keypad 55, a card reader 70 that receivers a customer's debit or credit card, a monitor or display 75 that displays information, and a dispenser 80 that dispenses currency. In the illustrated embodiment, the IA 10 is coupled to entire perimeter of the ATM, including the left 30, right 35, top 40 and bottom 45 surfaces. It will be appreciated that the lights 15 may not be mounted to all the surfaces. The function of the IA 10 described above in connection with FIGS. 1-2 applies to the automated teller machine as well, but now the lights 15 illuminate the wall surface adjacent to the ATM. The lights 15 are also capable of the different illumination functions described above.

It is to be noticed that the term “comprising”, used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Similarly, it is to be noticed that the term “coupled”, also used in the claims, should not be interpreted as being limitative to direct connections only.

Thus, it is seen that an illumination apparatus 10 is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives.

What is claimed is:

1. An apparatus, comprising:
an enclosure comprising a front surface and a bottom surface;
a dispensing element structured to dispense an article, the dispensing element located within the enclosure;
a customer selection element accessible by a customer to select the article, the customer selection element located on the front surface of the enclosure;
a currency receiver element structured to receive a currency for purchasing the article, the currency receiver element located on the front surface of the enclosure;
a receiving area located on the front surface of the enclosure, the receiving area structured to allow the customer to obtain the article after the article has been selected, purchased and dispensed; and
a light assembly coupled to a bottom surface of the enclosure, the light assembly comprising a plurality of visible-light emitting elements, and arranged to illuminate an area directly adjacent to the bottom surface of the enclosure.

2. The apparatus of claim 1, where the plurality of visible-light emitting elements emit a light that illuminates a surface located directly beneath the bottom surface of the enclosure.

3. The apparatus claim 1, where the plurality of visible-light emitting elements comprises at least one light emitter selected from a group consisting of: a illumination device, a field-induced polymer electroluminescent light, an incandescent light, a light-emitting diode (LED), a fluorescent light, a halogen light, a reflected light, a light provided by an optical fiber, and a combination of two or more thereof.

4. The apparatus of claim 1, where the apparatus detects an individual, and the plurality of visible-light emitting elements emit a light in a pattern selected from a group consisting of: increasing illumination, decreasing illumination, flashing, illuminating in a sequential pattern, and a combination of two or more thereof.

5. The apparatus of claim 1, where the dispensing element is selected from a group consisting of: an apparatus that includes a slot-type element for storing a beverage, an apparatus for storing an edible pre-packaged item, an apparatus for storing a non-edible item, an apparatus that includes a rotatable helical-shaped element, and a combination of two or more thereof.

6. The apparatus of claim 1, where the currency receiver element is selected from a group consisting of: a credit card reader, a bill acceptor, a coin acceptor, a token acceptor, a digital payment system, and a combination of two or more thereof.

7. The apparatus of claim 1, where the apparatus vends an item selected from a group consisting of: an edible item, a non-edible item, a beverage, a video game, a movie, a token, a voucher, a gift card, a credit card, a device containing electronic media, a time period for operating the apparatus, and a combination of two or more thereof.

8. An apparatus, comprising:
an enclosure comprising a front surface, a rear surface, a left surface, a right surface and a bottom surface, the enclosure sized to be locatable upon a counter-top so that a lower portion of each of the front, rear, left and right surfaces is adjacent to the counter-top;
a customer interface located on the front surface of the enclosure, the customer interface enabling the customer to operate the apparatus;
a currency receiver element structured to receive a currency enabling operation of the apparatus, the currency receiver element located on the enclosure; and
a light assembly coupled to a lower portion of each of the front, rear, left and right surfaces of the enclosure, the light assembly comprising a plurality of visible-light emitting elements, and arranged to illuminate an area of the counter-top directly adjacent to the apparatus.

9. The apparatus of claim 8, the enclosure further comprising:
a bottom surface that includes a support that positions the apparatus above the counter-top; and
a light assembly coupled to a bottom surface of the enclosure, the light assembly comprising a plurality of visible-light emitting elements, and arranged to illuminate an area directly beneath the bottom surface of the enclosure.

10. The apparatus of claim 8, where the counter-top comprises a horizontal surface elevated above a support surface upon which the operator stands.

11. The apparatus of claim 8, where the apparatus is selected from a group consisting of: an arcade game, a pachinko game, a game of chance, and a slot machine.

12. The apparatus claim 8, where the plurality of visible-light emitting elements comprises at least one light emitter selected from a group consisting of: a illumination device, a field-induced polymer electroluminescent light, an incandescent light, a light-emitting diode (LED), a fluorescent light, a halogen light, a reflected light, a light provided by an optical fiber, and a combination of two or more thereof.

13. The apparatus of claim 8, where the currency receiver element is selected from a group consisting of: a credit card reader, a matrix bar code reader, a bill acceptor, a coin acceptor, a token acceptor, a voucher acceptor, a keypad capable of receiving a code, and a combination of two or more thereof.

14. An apparatus, comprising:
an enclosure comprising a front surface, a left surface, a right surface, a top surface and a bottom surface, the enclosure sized to be located on a substantially vertical surface;
a customer interface located on the front surface of the enclosure, the customer interface enabling the customer to operate the apparatus;
a currency dispensing element structured to dispense a currency from the apparatus, the currency dispensing element located on a front surface of the enclosure; and
a light assembly coupled to at least one of the top, bottom, left and right surfaces of the enclosure, the light assembly comprising a plurality of visible-light emitting elements, and arranged to illuminate an area of the substantially vertical surface directly adjacent to the enclosure.

15. The apparatus of claim 14, where the apparatus comprises an automated teller machine.

16. The apparatus claim 14, where the plurality of visible-light emitting elements comprises at least one light emitter selected from a group consisting of: a illumination device, a field-induced polymer electroluminescent light, an incandescent light, a light-emitting diode (LED), a fluorescent light, a halogen light, a reflected light, a light provided by an optical fiber, and a combination of two or more thereof.

17. An apparatus, comprising:
a substantially rectangular enclosure comprising a top surface, a bottom surface, and four side surfaces;
at least four support elements extending from the substantially rectangular enclosure, the at least four support elements sized to position the top surface above a ground plane;
a currency receiver element structured to receive a currency enabling operation of the apparatus, the currency receiver element located on the substantially rectangular enclosure; and
a light assembly coupled to a bottom surface of the substantially rectangular enclosure, the light assembly comprising a plurality of visible-light emitting elements, and arranged to illuminate an area directly adjacent to the bottom surface of the enclosure.

18. The apparatus of claim 17, where the plurality of visible-light emitting elements emit a light that illuminates a surface located directly beneath the bottom surface of the substantially rectangular enclosure.

19. The apparatus claim 17, where the plurality of visible-light emitting elements comprises at least one light emitter selected from a group consisting of: a illumination device, a field-induced polymer electroluminescent light, an incandescent light, a light-emitting diode (LED), a fluorescent light, a halogen light, a reflected light, a light provided by an optical fiber, and a combination of two or more thereof.

20. The apparatus of claim 17, where the apparatus is selected from a group consisting of: a pool table, a billiards table, an air hockey table, and a pinball machine.

21. The apparatus of claim 17, where the currency receiver element is selected from a group consisting of: a credit card reader, a matrix bar code reader, a bill acceptor, a coin acceptor, a token acceptor, a voucher acceptor, a keypad capable of receiving a code, and a combination of two or more thereof.

22. An apparatus, comprising:
an enclosure comprising a front surface and a bottom surface;
a display element structured to display information, the display element located within the enclosure;
a customer selection element accessible by a customer to operate the display, the customer selection element located on the front surface of the enclosure; and
a light assembly coupled to a bottom surface of the enclosure, the light assembly comprising a plurality of visible-light emitting elements, and arranged to illuminate an area directly adjacent to the bottom surface of the enclosure.

23. The apparatus of claim 1, where the plurality of visible-light emitting elements emit a light that illuminates a surface located directly beneath the bottom surface of the enclosure.

24. The apparatus claim 1, where the plurality of visible-light emitting elements comprises at least one light emitter selected from a group consisting of: a illumination device, a field-induced polymer electroluminescent light, an incandescent light, a light-emitting diode (LED), a fluorescent light, a halogen light, a reflected light, a light provided by an optical fiber, and a combination of two or more thereof.

25. The apparatus of claim 1, where the apparatus detects an individual, and the plurality of visible-light emitting elements emit a light in a pattern selected from a group consisting of: increasing illumination, decreasing illumination, flashing, illuminating in a sequential pattern, and a combination of two or more thereof.
